(19) United States
(12) Patent Application Publication
(10) Pub. No.: US 2025/0020838 A1
(43) Pub. Date: Jan. 16, 2025

(54) REFLECTIVE OPTICAL ELEMENT FOR A WAVELENGTH IN THE EXTREME ULTRAVIOLET WAVELENGTH RANGE

(71) Applicant: Carl Zeiss SMT GmbH, Oberkochen (DE)

(72) Inventor: Alexandra PAZIDIS, Essingen-Lauterburg (DE)

(21) Appl. No.: 18/903,521

(22) Filed: Oct. 1, 2024

Related U.S. Application Data
(63) Continuation of application No. PCT/EP2023/058785, filed on Apr. 4, 2023.

(30) Foreign Application Priority Data
Apr. 7, 2022 (DE) 10 2022 203 495.3

(51) Int. Cl. G02B 5/08

(52) U.S. Cl. CPC G02B 5/0891

(57) ABSTRACT

This disclosure relates to a reflective optical element for a wavelength in the extreme ultraviolet wavelength range, comprising a substrate and a reflective coating designed as a multi-layer system. The multi-layer system has alternating layers of at least two different base materials different real parts of their refractive indexes in the extreme ultraviolet wavelength range. An electrical field standing wave is formed in the multilayer system by the reflection of extreme ultraviolet wavelength radiation. The multi-layer system has another material at least in a layer at a point of extreme field intensity, wherein the reflective optical element has a material as the other material at at least one point of minimal field intensity, which has greater absorption for the reflected wavelength than the at least partially replaced one.

### CROSS REFERENCE TO RELATED APPLICATIONS

This is a Continuation of International Application PCT/EP2023/058785, which has an international filing date of Apr. 4, 2023, and which claims the priority of German Patent Application 10 2022 203 495.3, filed Apr. 7, 2022. The disclosures of both applications are incorporated in their respective entireties into the present Continuation by reference.

### FIELD

The techniques of the present disclosure relate to reflective optical elements for wavelengths in the extreme ultraviolet wavelength range, comprising a substrate and a reflective coating in the form of a multilayer system. The disclosed techniques further relate to an optical system having a reflective optical element.

### BACKGROUND

In EUV lithography apparatuses, reflective optical elements for the extreme ultraviolet (EUV) wavelength range (for example wavelengths of between approximately 5 nm and 20 nm), such as photomasks or mirrors on the basis of multilayer systems, are used for the lithography of semiconductor components. Since EUV lithography apparatuses generally have a plurality of reflective optical elements, these need to have as high a reflectivity as possible in order to ensure a sufficiently high overall reflectivity for the optical system.

Reflective optical elements with multilayer systems which are designed for a wavelength of approximately 13.5 nm at quasi-normal incidence and are based on alternatingly arranged layers of molybdenum and silicon have proven themselves, in particular, for applications in EUV lithography. Both materials have at these wavelengths a low absorption, that is to say a small imaginary part of the refractive index and a sufficiently large difference in the real part of the refractive index in order to provide good maximum reflectivity. There are material pairs with a greater difference in the real part of the refractive index. However, one or both materials at the particular wavelengths have a greater absorption, meaning that multilayer systems based thereon have a lower maximum reflectivity.

### SUMMARY

It is an object of the techniques disclosed herein to propose a reflective optical element having greater reflectivity.

This object is achieved by a reflective optical element for a wavelength in the extreme ultraviolet wavelength range, comprising a substrate and a reflective coating in the form of a multilayer system, wherein the multilayer system comprises layers of at least two different base materials with a different real part of the refractive index at a wavelength in the extreme ultraviolet wavelength range, the layers being arranged in alternation, and at which a standing wave of an electric field is formed upon reflection of a wavelength in the extreme ultraviolet wavelength range, wherein the multilayer system has in at least one layer at a place of extreme field intensity of the standing wave a further material, which at least partially replaces one of the at least two different base materials in the at least one layer at a place of extreme field intensity, and wherein the reflective optical element has at at least one place of minimum field intensity, as a further material, a material that has a greater absorption at the reflective wavelength than the one it has at least partially replaced.

It has been found by the inventor that reflectivity increases can be achieved if during the design of a multilayer system as a reflective coating for a reflective optical element the profile of the standing wave forming during reflection within the multilayer system is taken into account. Due to the fact that in one or more layers located at special places of the standing wave, in particular with particularly high or particularly low intensity, material is provided which differs from the at least two different base materials on which the multilayer system is based and which have a different real part of the refractive index at a wavelength in the extreme ultraviolet wavelength range, the maximum reflectivity at quasi-normal radiation incidence can be increased. In particular for the use in optical systems in which a plurality of reflective optical elements are connected one after the other in the beam path, even small reflectivity increases at individual reflective optical elements can be advantageous because their effect multiplies. Due to the complete replacement of the originally provided base material, the additional effort during application of the multilayer system onto a substrate can be kept as low as possible. Due to the only partial replacement, with finer adjustment on the profile of the standing wave, the reflectivity increase can be additionally increased.

Preferably, the further material has a greater difference in the real part of the refractive index with respect to the real part of the refractive index of the at least one base material which has not been at least partially replaced than the at least partially replaced base material. As a result, material combinations can be achieved locally in which the gain of maximum reflectivity outweighs any absorption losses.

In some examples, the reflective optical element has at at least one place of maximum field intensity, as an additional further material, a material which has a lower absorption at the reflected wavelength than the base material it has at least partially replaced. In this case, the additional further material preferably has a smaller difference in the real part of the refractive index with respect to the real part of the refractive index of the at least one base material which has not been at least partially replaced thereby than the base material which has been at least partially replaced thereby. It is also possible in this case to achieve locally material combinations in which the gain of maximum reflectivity outweighs any absorption losses.

In particular examples, the multilayer system has molybdenum and silicon as at least two different materials with a different real part of the refractive index. Such multilayer systems have a high maximum reflectivity in particular at wavelengths of approximately 13.5 nm and have established themselves in particular in the field of EUV lithography.

Especially in this case it has proven to be particularly advantageous if the reflective optical element has in its multilayer system serving as a reflective coating, as a further material, one or more of the group consisting of palladium, rhodium, ruthenium, technetium, niobium, lanthanum, barium, cerium, praseodymium, rubidium and strontium. Palladium, rhodium, ruthenium and technetium are particularly suitable for at least partially replacing molybdenum in one layer at a place with a particularly low field intensity, and lanthanum, barium, cerium, and praseodymium are particularly suitable for at least partially replacing silicon in such a layer. Niobium is particularly suitable for at least partially replacing molybdenum in one layer at a place with a particularly high field intensity, and rubidium and strontium are particularly suitable for at least partially replacing silicon in such a layer.

Furthermore, the object may be achieved by an optical system which has a reflective optical element as described above. Such optical systems are suitable in particular for use in EUV lithography apparatuses, but also in apparatuses for the optical inspection of wafers and masks and also mirrors.

### BRIEF DESCRIPTION OF THE DRAWINGS

The techniques of the present disclosure will be explained in more detail with reference to preferred exemplary embodiments, in which:

FIG. 1 shows a schematic illustration of an EUV lithography apparatus;

FIG. 2 shows a schematic illustration of a conventional reflective optical element;

FIG. 3A shows a schematic illustration of a further conventional reflective optical element with a standing wave formed;

FIG. 3B shows a standing wave forming upon reflection at the reflective optical element from FIG. 3A;

FIG. 4 shows a schematic illustration of a first reflective optical element;

FIG. 5 shows a schematic illustration of a second reflective optical element;

FIG. 6 shows a schematic illustration of a third reflective optical element;

FIG. 7 shows a schematic illustration of a fourth reflective optical element;

FIG. 8 shows a schematic illustration of a fifth reflective optical element; and

FIG. 9 shows a schematic illustration of a sixth reflective optical element.

### DETAILED DESCRIPTION

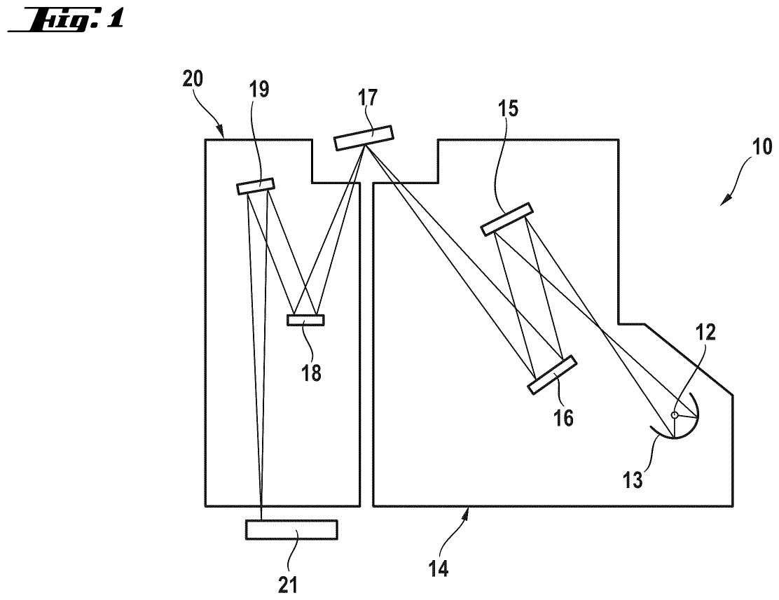

FIG. 1 schematically illustrates an EUV lithography apparatus 10 by way of example. The components illustrated in FIG. 1 are the illumination system 14, the photomask 17, and the projection system 20. The EUV lithography apparatus 10 is operated under vacuum conditions, so that the EUV radiation in its interior is absorbed as little as possible.

The radiation source 12 used can be, for example, a plasma source or a synchrotron. In the example shown here, it is a laser-operated plasma source. The emitted radiation in the wavelength range of approximately 5 nm to 20 nm is initially focused by the collector mirror 13. The operating beam 11 is then introduced onto the reflective optical elements following in the beam path in the illumination system 14. In the example shown in FIG. 1, the illumination system 14 has two further mirrors 15, 16. The mirrors 15, 16 guide the beam onto the photomask 17, which has the structure that is to be imaged onto the wafer 21. The photomask 17 is likewise a reflective optical element for the EUV wavelength range which can be exchanged depending on the manufacturing process. Using the projection system 20, the beam reflected by the photomask 17 is projected onto the wafer 21, and in this way the structure of the photomask is imaged on the latter. The projection system 20 has two mirrors 18, 19 in the example shown. It should be noted that both the projection system 20 and also the illumination system 14 may each have only one or even three, four, five and more mirrors.

Each of the mirrors 13, 15, 16, 18, 19 shown here and also the mask 17 for use in the extreme ultraviolet wavelength range can have a substrate and a reflective coating in the form of a multilayer system, wherein the multilayer system comprises layers of at least two different base materials with a different real part of the refractive index at a wavelength in the extreme ultraviolet wavelength range, with the layers being arranged in alternation, and at which a standing wave of an electric field is formed upon reflection of a wavelength in the extreme ultraviolet wavelength range, wherein the multilayer system has a further material in at least one layer at a place of extreme field intensity of the standing wave. In particular, the further material at least partially replaces one of the at least two different base materials in the at least one layer at a place of extreme field intensity, wherein the reflective optical element has at at least one place of minimum field intensity, as a further material, a material which has a greater absorption at the reflected wavelength than the one which has been at least partially replaced.

Such reflective optical elements can also be used in wafer inspection systems or mask inspection systems.

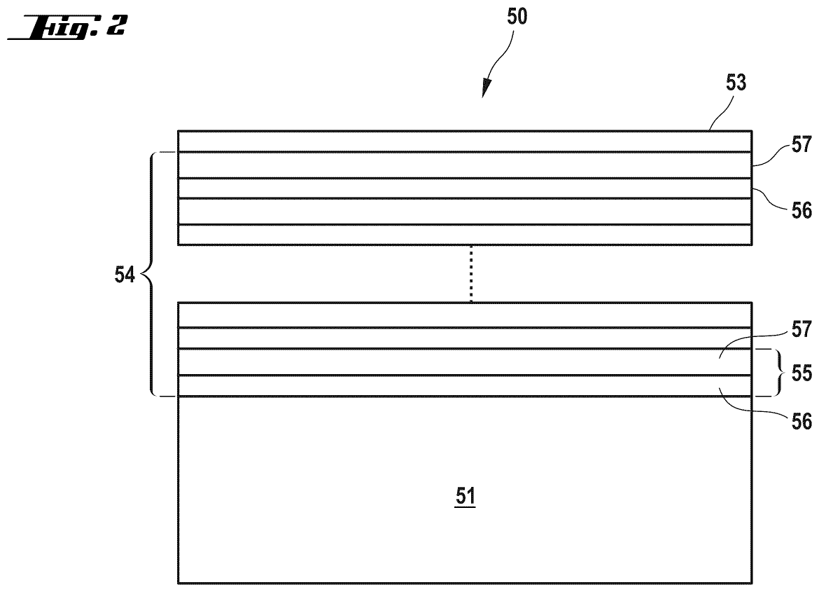

FIG. 2 schematically illustrates the construction of an EUV mirror 50, the reflective coating of which is based on a multilayer system 54. The multilayer system 54 consists of layers, applied in alternation to a substrate 51, of a base material (also referred to as spacer 57) with a high real part of the refractive index at the operating wavelength at which, for example, the lithographic exposure is carried out, and of a base material (also referred to as absorber 56) with a lower real part of the refractive index at the operating wavelength, wherein one absorber-spacer pair forms one stack 55. In this way, a crystal is simulated, as it were, the lattice planes of which correspond to the absorber layers at which Bragg reflection takes place. Typically, reflective optical elements for an EUV lithography apparatus or an optical system are designed such that the respective wavelength of maximum reflectivity substantially corresponds to the operating wavelength of the lithography process or other applications of the optical system.

The thicknesses of the individual layers 56, 57 and also the stack 55, which repeats itself, can be constant over the entire multilayer system 54 or can vary over the surface or the total thickness of the multilayer system 54, depending on which spectral or angle-dependent reflection profile or which maximum reflectivity is to be achieved at the operating wavelength. Furthermore, additional layers can also be provided as diffusion barriers between spacer and absorber layers 56, 57. In addition, a protective layer 53 can be provided on the multilayer system 54, which protective layer can itself also be multilayered.

Typical substrate materials for reflective optical EUV-lithographic elements are silicon, silicon carbide, silicon-infiltrated silicon carbide, quartz glass, titanium-doped quartz glass, glass, and glass ceramic. In particular, with such substrate materials, additionally a layer can be provided between the multilayer system 54 and the substrate 51 which is made of a material that has a high absorption for radiation in the EUV wavelength range, which is used during operation of the reflective optical element 50 to protect the substrate 51 from radiation damage, for example unwanted compacting. Furthermore, the substrate can also be made of copper, aluminum, a copper alloy, an aluminum alloy or a copper-aluminum alloy. Between the substrate 51 and the multilayer system 54 one or more layers or layer systems can also be arranged which assume functions other than optical functions, for example the compensation or reduction of layer stresses induced in a multilayer system 54 which forms a reflective coating. Furthermore, an adhesion promoting layer can also be provided between the substrate 51 and the multilayer system 54.

FIG. 3A shows a reflective optical element 50, as described above, which has on a substrate 51 a multilayer system 54 which in the present example terminates with respect to the vacuum 52 without a protection layer. In the present example, the multilayer system 54 has fifty four layers of molybdenum as the absorber layer 56 and silicon as the spacer layer 57 in alternation. In addition, FIG. 3B plots the standing wave 60, which forms upon reflection, as field intensity in percent over the thickness d in nm of the reflective optical element 50. This standing wave has diverse extremes, in particular minima 61 and maxima 62. The absorption of the incoming radiation is the highest at the maxima 62. The maxima become smaller in the direction of the substrate 51. This provides a region of comparatively low absorption in the region close to the substrate. In addition, minima are located in each case at the transition from a molybdenum layer to a silicon layer, specifically in the direction from the vacuum 52 toward the substrate 51. The multilayer system 54, shown here by way of example, is designed for incoming radiation of a wavelength of 13.6 nm and has a maximum reflectivity of 72.35% under quasi-normal incidence.

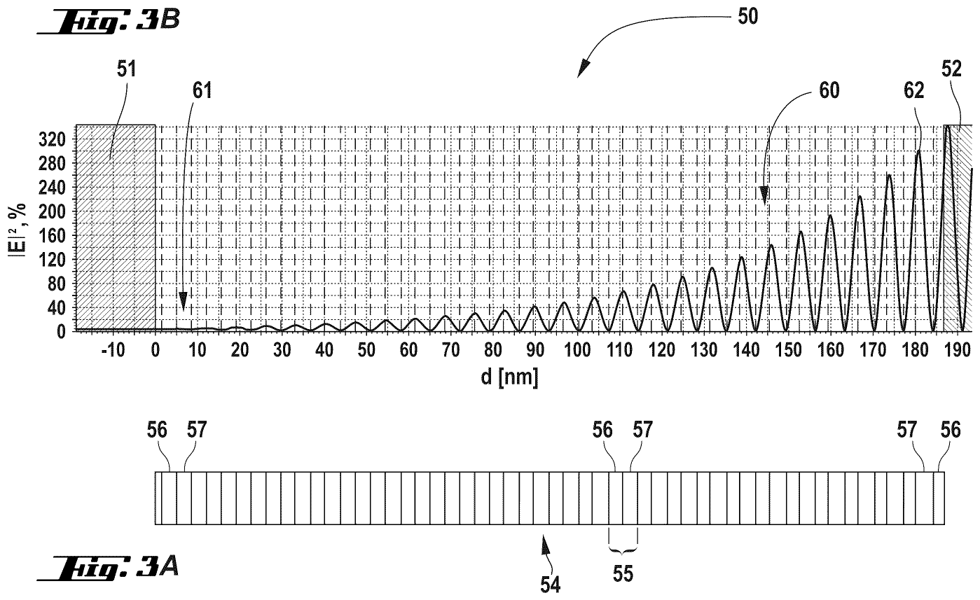

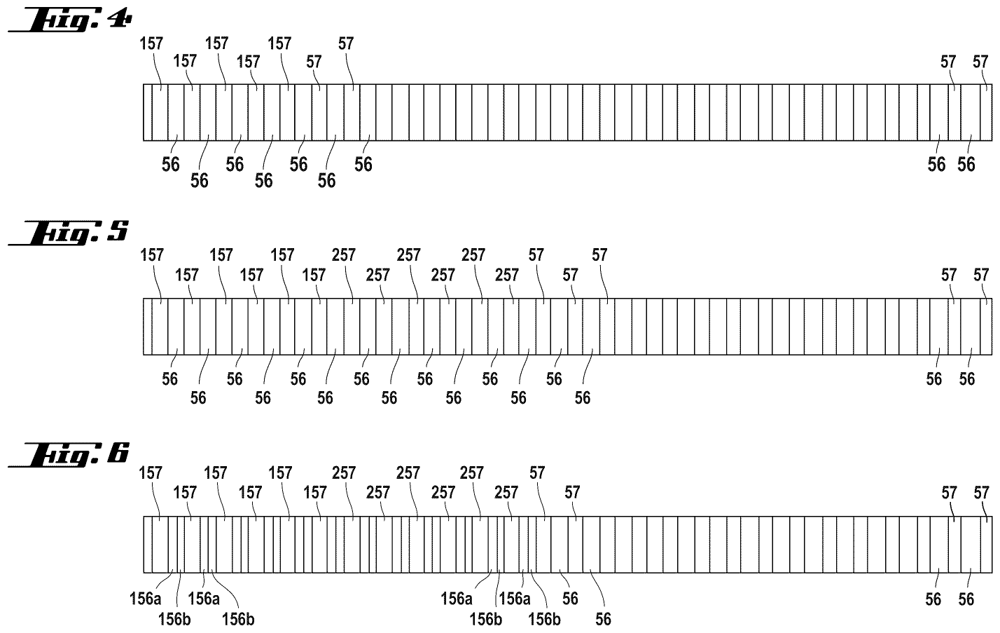

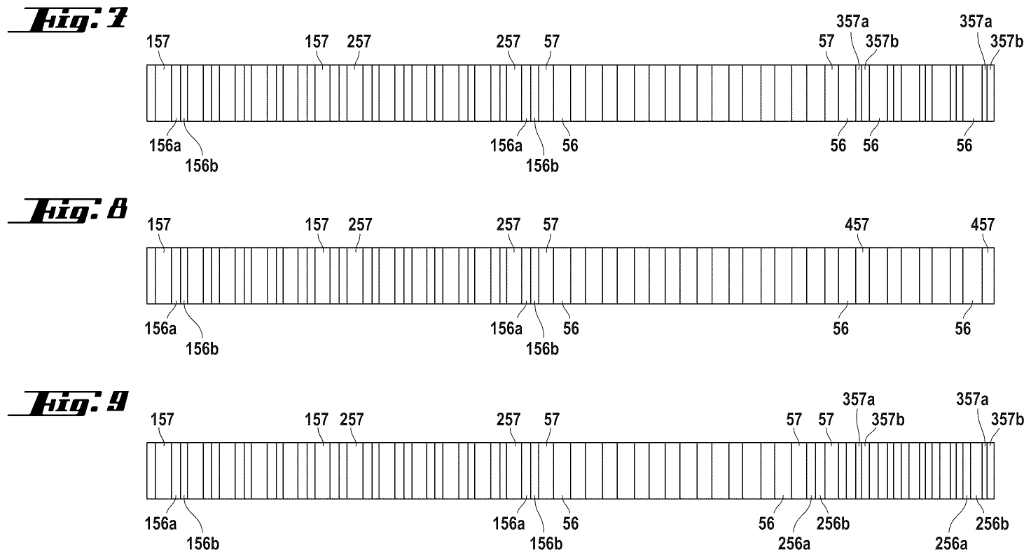

FIGS. 4 to 9 which follow show by way of example a few variants of the multilayer system 54 shown in FIG. 3A, which have been modified according to the disclosed techniques, which together with the substrate 51 carrying them form reflective optical elements 50 according to the disclosed techniques. All these variants are designed, like the initial multilayer system 54 shown in FIG. 3A, for a wavelength of 13.6 nm in a typical manner.

In the first variant shown in FIG. 4, the molybdenum in the five absorber layers 157 closest to the substrate is replaced entirely by rhodium. The remaining absorber layers 57 are, like in the initial system shown in FIG. 3A, made of molybdenum, and all spacer layers 56 are made of silicon. While rhodium does have a greater imaginary part of the refractive index than molybdenum at 13.6 nm, it has a greater difference in the real part of the refractive index with respect to that of silicon. Since rhodium replaces molybdenum only in layers at places with a very low field intensity of the standing wave, the effect of the higher refractive index difference outweighs the effect of the higher absorption, which means that, in sum, a higher reflectivity can be achieved. This first variant has, upon quasi-normal incidence, a maximal reflectivity of 73.4%. Alternatively, the molybdenum could also be replaced not by rhodium but by palladium, ruthenium or technetium. Even if the molybdenum is replaced by the highly-absorptive palladium, it still achieves a maximum reflectivity of 73.18%.

In the variant illustrated in FIG. 5, in absorber layers 157, 257 close to the substrate, molybdenum is replaced not by one, but by two further materials. In the example shown here, the molybdenum was replaced in the six absorber layers 157 close to the substrate by rhodium and in the subsequent six absorber layers 257, which follow in the direction away from the substrate, by the somewhat less absorptive ruthenium, which, however, also has a somewhat lower refractive index difference with respect to silicon than rhodium. The spacer layers 46 are all made of silicon. With this modification, a maximum reflectivity of 73.68% at quasi-normal incidence at 13.6 nm is achieved. In the aforementioned layers it is likewise possible to use, instead of rhodium and ruthenium, palladium and rhodium or ruthenium or technetium, or rhodium and technetium, or ruthenium and technetium, in order to achieve a reflectivity increase compared to the initial system made of only molybdenum and silicon.

A further variant based on the variant shown in FIG. 5 is shown in FIG. 6. In addition to the modifications shown in FIG. 5, in this variant the twelve spacer layers 156a,b closest to the substrate have also been modified. In these spacer layers, the silicon has been replaced only partially by lanthanum in the present example, specifically on the side facing the vacuum, with the result that the partial layers 156a are made of silicon and the partial layers 156b are made of lanthanum. The remaining spacer layers 56 are entirely made of silicon. Lanthanum has a higher absorption at 13.6 nm than silicon and a higher refractive index difference with respect to molybdenum and its aforementioned substitutes. Since lanthanum replaces silicon only in layers at places with a very low field intensity of the standing wave, and there in the region of minima, the effect of the higher refractive index difference outweighs the effect of the higher absorption, which means that, in sum, a higher reflectivity can be achieved. The multilayer system shown in FIG. 6 achieves a maximum reflectivity of 73.73% at quasi-normal incidence of radiation of a wavelength of 13.6 nm. Rather than lanthanum, barium, cerium and praseodymium are also suitable to entirely or partially replace silicon in layers with a particularly low field intensity.

In the variant shown in FIG. 7, the variant shown in FIG. 6 was developed further. In addition to the modifications which have already been mentioned, the molybdenum in the five absorber layers 357a,b closest to the vacuum is partially replaced by ruthenium, specifically in each case on the side facing away from the vacuum, with the result that the absorber partial layer 357a is made of ruthenium and the absorber partial layer 357b is made of molybdenum. On the side of these absorber layers facing away from the vacuum, there is in each case a minimum of the standing wave, with the result that the higher absorption of the ruthenium has less of an impact there then the greater refractive index difference with respect to the silicon. In this way, at a quasi-normal incidence at 13.6 nm, a maximum reflectivity of 74.2% can be achieved. Alternatively, the molybdenum could also be replaced by palladium, rhodium or technetium on the side of the respective layer facing away from the vacuum.

The variant shown in FIG. 8 is also a further development of the variant shown in FIG. 6. Instead of replacing molybdenum in the five absorber layers 457 closest to the vacuum by a higher-absorbing material, it was replaced here by the less absorbent niobium, which also has a lower refractive index difference with respect to silicon at 13.6 nm. Alternatively, a merely partial replacement can take place on the side of the respective layers facing the vacuum, where in each case field intensity maxima are located, with the result that the respective material absorption has a particularly strong impact. This variant also exhibits a reflectivity increase compared to the variant shown in FIG. 6.

The variant shown in FIG. 9 is based on the variant shown in FIG. 7. In addition to the modifications discussed in connection with FIG. 7, silicon was replaced by rubidium in the six spacer layers 256a,b closest to the vacuum on the side of the respective layer facing away from the vacuum. Consequently, the spacer partial layer 256a consists of rubidium, and the spacer partial layer 257b consists of silicon. The spacer partial layers 256a are located in a region of maximum field intensity of the standing wave, where the absorption of the material located there has a particularly strong impact. Since a material that is less absorbent than silicon is provided there, the effect of the lower absorption of the incident radiation outweighs the effect of the lower refractive index difference, with the result that a reflectivity increase at quasi-normal incidence of radiation of a wavelength of 13.6 nm to a maximum reflectivity of 76.2% can be achieved. Alternatively, silicon in spacer layers close to the vacuum can be entirely or partially replaced by rubidium or strontium.

In further modifications, it is possible for only one, two, three, four, five, six, seven, eight, nine, ten, twelve, thirteen, fourteen, fifteen or more absorber layers and/or spacer layers to be modified in the region of the respective multilayer system close to the substrate or to the vacuum. In the process, account is advantageously taken of how many layers the respective multilayer system has in total. In addition, it should also be taken into account that the creation of new boundary surfaces with merely partial material replacement within layers can contribute to an increase in roughness, which in turn can reduce the reflectivity. In certain circumstances, when producing the corresponding reflective optical elements, the coating methods can be selected regarding a roughness that is as low as possible, or additional smoothing methods may be performed. In addition, it is possible for not only one or two, but also three of four or more different materials to be used to replace the original absorber or spacer material.

It should be noted that in the multilayer systems shown here, additional layers may be provided which act as diffusion barriers. These may be arranged between two layers of base materials, but also between one layer of a base material and a further material, or between two layers of further materials. The layers of base materials or further materials may also be partial layers. In particular if the base materials are molybdenum and silicon, as in the examples discussed here in detail, the barrier layers can be made of carbon, boron carbide, silicon nitride, silicon carbide or of a composition with at least one of these materials.

Optical systems which have at least one reflective optical element according to the disclosed techniques exhibit increased light yield. As many reflective optical elements as possible or even all of the reflective optical elements provided in the respective optical system are designed here with a multilayer system proposed as a reflective coating. They are suitable in particular as optical systems for EUV lithography apparatuses or likewise for other applications, such as mask or wafer inspection apparatuses. If the optical system has, for example, eight reflective optical elements according to the disclosed techniques, which each exhibit a reflection increase by 2% with respect to a conventional reflective optical element, the total achieved is a relative increase of the light yield by 24%.

### REFERENCE SIGNS

10 EUV lithography apparatus
11 Operating beam
12 EUV radiation source
13 Collector mirror
14 Illumination system
15 First mirror
16 Second mirror
17 Mask
18 Third mirror
19 Fourth mirror
20 Projection system
21 Wafer
50 Reflective optical element
51 Substrate
52 Vacuum
53 Protective layer
54 Multilayer system
55 Layer pair
56 Spacer
57 Absorber
60 Field intensity
61 Minimum field intensity
62 Maximum field intensity
156a,b Spacer
157 Absorber
256a,b Spacer
257 Absorber
357a,b Absorber
457 Absorber

What is claimed is:

1. A reflective optical element for a wavelength in an extreme ultraviolet wavelength range, comprising:
a substrate; and
a reflective coating comprising a multilayer system,
wherein the multilayer system comprises:
alternating layers of a first base material and layers of a second base material, the first base material having a real part of a refractive index at a wavelength in the extreme ultraviolet wavelength range that differs from a real part of a refractive index of the second base material at the wavelength in the extreme ultraviolet wavelength range, in which radiation having the wavelength in the extreme ultraviolet wavelength range reflected by the multilayer system forms a standing wave,
a layer arranged at a place of extreme field intensity of the standing wave within the multilayer system comprised of a first further material which at least partially replaces one of the first base material or the second base material in the layer arranged at the place of extreme field intensity, and
the first further material has a greater absorption at the wavelength in the extreme ultraviolet wavelength range than the first base material or the second base material that has been at least partially replaced by the first further material.

2. The reflective optical element of claim 1, wherein a difference between a real part of the refractive index of the first further material and the real part of the refractive index of the first base material or the second base material which has not been at least partially replaced by the first further material is greater than a difference between the real part of the refractive index of the first base material or the second base material which has not been at least partially replaced by the first further material and the real part of the refractive index of the first base material or the second base material which has been at least partially replaced by the first further material.

3. An optical system comprising a reflective optical element as claimed in claim 2.

4. The reflective optical element of claim 1, further comprising, at at least one place of maximum field intensity, a second further material that at least partially replaces the first base material or the second base material and has a lower absorption at the wavelength in the extreme ultraviolet wavelength range reflected by the multilayer system than the first base material or the second base material which has been at least partially replaced by the second further material.

5. An optical system comprising a reflective optical element as claimed in claim 4.

6. The reflective optical element of claim 4, wherein a real part of the refractive index of the second further material differs less from the real part of the refractive index of the first base material or the second base material which has not been at least partially replaced by the second further material than from the real part of the refractive index of the first base material or the second base material which has been at least partially replaced by the second further material.

7. The reflective optical element of claim 4, wherein the first further material and the second further material completely replaced the first base material or the second base material in the layer arranged at the place of extreme field intensity of the standing wave.

8. The reflective optical element of claim 1, wherein the multilayer system has molybdenum as the first base material and silicon as the second base material.

9. An optical system comprising a reflective optical element as claimed in claim 8.

10. The reflective optical element of claim 8, wherein the first further material is selected from the group consisting of palladium, rhodium, ruthenium, technetium, niobium, lanthanum, barium, cerium, praseodymium, rubidium, and strontium.

11. An optical system comprising a reflective optical element as claimed in claim 10.

12. An optical system comprising a reflective optical element as claimed in claim 1.
